(19) United States
(12) Patent Application Publication
(10) Pub. No.: US 2009/0319525 A1
(43) Pub. Date: Dec. 24, 2009

(54) LOST WRITE PROTECTION VIA STREAM-BASED REPLICATION

(75) Inventors: Gregory Thiel, Black Diamond, WA (US); Andrew E. Goodsell, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/144,613

(22) Filed: Jun. 23, 2008

(51) Int. Cl. G06F 7/02

(52) U.S. Cl. 707/8

(57) ABSTRACT

Architecture for detecting lost writes using timestamps. During a replication process, lost writes in data replicated from a stream can be detected by noting discrepancies between the timestamps of data in the replica and timestamps associated with the corresponding data from the source in original data store. A lost write either in the original data store or in the replica data store can be inferred by comparing these timestamps with the timestamps in a number of other replica data stores. Additionally, check entries can be added to the replicas by the original data store to allow expanded comparison between recently modified data and the source data in the original data store. The check entries can be added to the replication journal after a time delay, thereby increasing effectiveness of the check by decreasing the likelihood that caching in the hardware will defeat the test.

### BACKGROUND

Server applications typically provide a high level of availability to users. In the past, this availability has been addressed by increasing the resilience and expense of the hardware used to host those applications. There is a current trend where standard-type server applications function with the same reliability but on cheaper hardware. For example, the software as a service (SaaS) paradigm is pushing many server applications into an Internet datacenter where they are hosted on giant pools of commodity hardware. The application adapts to the limitations of this hardware for the service to be successful.

Certain specific reliability problems are associated with the storage subsystems of this commodity hardware. At the present time, a hard disk can contain more than one million lines of code, and a disk controller can be just as complicated. Such software typically has “bugs” but commodity hardware has little redundancy to compensate for the bugs.

In updating data in a server application, a replication operation (e.g., log shipping) is performed in which transaction log backups are sent from a source (e.g., an initial data store such as an initial database on an initial server instance) to a replica (e.g., one or more secondary data stores such as databases on associated secondary server instances). Data is copied from the source to the replica for storage therewith through a number of writes.

In the event that errors occur in replication, one type of fault in the replication process is called a “lost write.” A lost write (or a “lost flush”) is a write that the replication process indicates as “completed” yet is not reflected in the data store. In other words, a lost write typically occurs to a data store that is being replicated. After a write is completed and a read is later performed, the data at the indicated location is missing or incorrect. For example, older data or blank data can be found at the location of the lost write.

Lost write events can be difficult to detect because the lost writes frequently are not self-evident and thus require additional (and often expensive) diagnostics or verification steps to prove. Additionally, “read after write verification” steps can be defeated by disk caches, which immediately read back the recorded data, incorporating any errors other than lost writes, and therefore do not necessarily indicate that the correct data was recorded.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

To that end, architecture is disclosed for detecting lost writes via stream-based replication. During a replication process, lost writes in data replicated via a stream can be detected by noting discrepancies between the timestamps of data in the replica and timestamps associated with the corresponding data from the source in an original data store. Additionally, a lost write, either in the original data store or in the replica data store, can be inferred by comparing these timestamps with the timestamps in a number of other replica data stores. Check entries can be added to the replicas by the original data store to allow expanded comparison between recently modified data and the source data in the original data store. The check entries can be added to the replication journal after a time delay, thereby increasing effectiveness of the check by decreasing the likelihood that caching in the hardware will defeat the test.

To the accomplishment of the foregoing and related ends, certain illustrative aspects are described herein in connection with the following description and the annexed drawings. These aspects are indicative of the various ways in which the principles disclosed herein can be practiced, all aspects and equivalents of which are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented data management system.

FIG. 2 illustrates an alternative embodiment of a computer-implemented data management system.

FIG. 3 illustrates an alternative embodiment of a computer-implemented data management system including detection components and replica data stores.

FIG. 4 illustrates components that can be optionally incorporated into the detection component.

FIG. 5 illustrates components that can be optionally incorporated into the writing component.

FIG. 6 illustrates a data management method.

FIG. 7 illustrates aspects of a verification process in a data management method.

FIG. 8 illustrates aspects of a check entry process in a data management method.

FIG. 9 is a flow chart illustrating further aspects of the process of lost write detection in a data management method.

FIG. 10 illustrates a computing system operable to execute lost write protection in accordance with the disclosed architecture.

FIG. 11 illustrates a computing environment that facilitates lost write protection in accordance with the disclosed architecture.

### DETAILED DESCRIPTION

The disclosed architecture relates to a computer-implemented data management system (e.g., messaging). A replication process is used by a server (e.g., messaging) in connection with data replication. A writing component writes data from a source data store to a replica data store. A monitor component monitors the timestamps of the data written to the replica data store and cooperates with a detection component which detects lost writes by comparing the timestamps of the respective data in a replica stream from the source data store and in the replica data store. This comparison identifies mismatches in the respective timestamps that correspond to the lost writes.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof The intention is to cover all modifications, equivalents, and alternatives falling within the spirit and scope of the claimed subject matter.

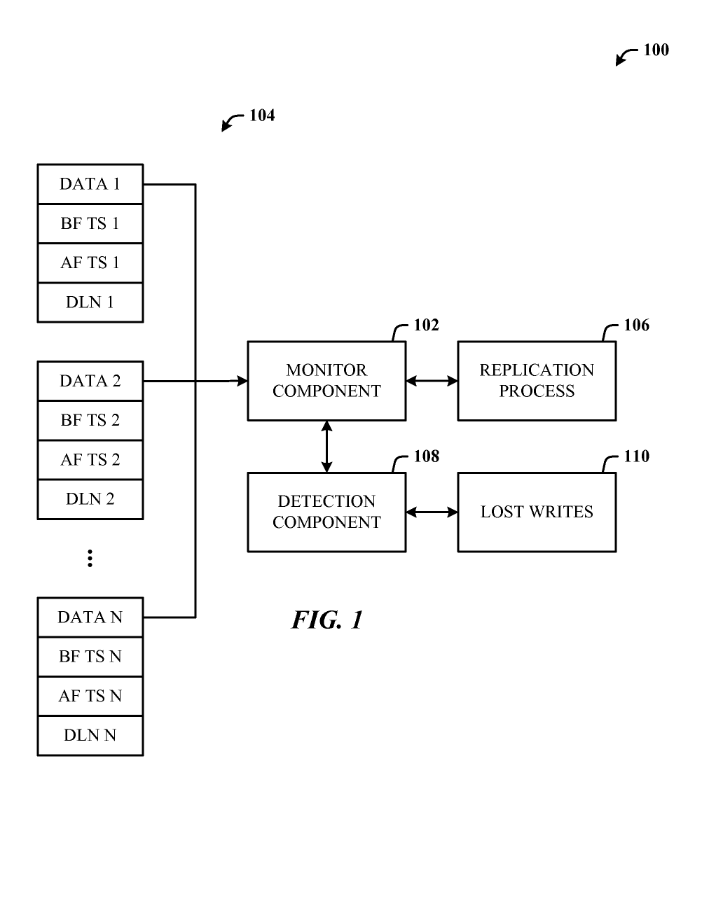

FIG. 1 illustrates a computer-implemented data management system 100. The system 100 can be a component in a messaging server, for example, or other suitable computer system for recording data. As used herein, “server” is particularly intended to refer to a server application operating on a dedicated hardware system. However, it should be appreciated that this term is not so-limited, and can alternatively be construed as any suitable software or hardware component or combination thereof.

The data management system 100 includes a monitor component 102 for monitoring timestamps associated with data elements 104 used in conjunction with a replication process 106 as part of data replication. The replication process 106 can be performed by a suitable type of replication, such as log shipping or other type of replication. A detection component 108 (as part of the replication target) detects lost writes 110 based in part on the timestamps, as discussed in greater detail hereinbelow. Thus, lost writes can be detected essentially for free as a part of the replication process.

In this data replication operation, the system 100 creates a journal of entries for each of the data elements 104 to be updated to the stream (wherein “stream” as used herein connotes a set of data broken down into a succession of elements, for purpose of replication). The journal entries associated with the data elements 104 in the stream can include a “before” timestamp (denoted BF TS) and an “after” timestamp (denoted AF TS) associated with the respective update. Each of the elements 104 can also include data location information or number (denoted DLN) of the data (denoted DATA). The location of each of the data elements 104 in the source data store 204 to be updated also contains a similar timestamp.

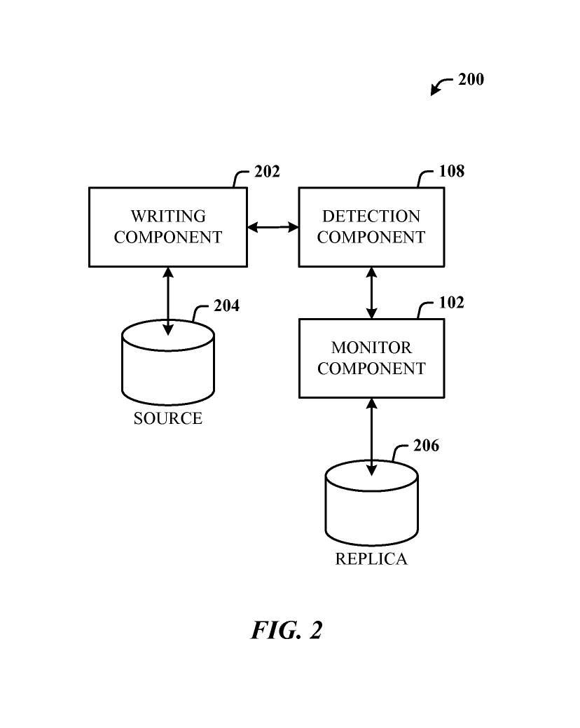

FIG. 2 illustrates an alternative embodiment of a computer-implemented data management system 200 that incorporates the monitor component 102 and the detection component 108 of the data management system 100 as shown in FIG. 1. A writing component 202 is included for writing the data from a source data store 204 into a replication stream to a replica data store 206.

The system 200 can use log shipping, a type of journaling system in which database updates are performed, though it is to be appreciated that other systems besides log shipping can also be used. To protect against a server crash or other system fault, updates to the source data store 204 are also written to a journal or transaction log, which can be read out to obtain a list of update operations, thereby allowing confirmation in the event of a system fault. The transaction logs are copied as a series of data elements (e.g., the data elements 104 of FIG. 1) to the replica data store 206, as part of replicating the data.

The stream is used to replicate each of the data elements to be updated from the source data store 204 to respective locations in one or more of the replica data stores 206. The data elements are present in the stream, but may or may not be present on the source data store 204 and/or the replica data store(s) 206. For example, if this is an insert operation then the data will be on the source 204 but not on the replica 206. If it is a delete operation, the data will be on the replica 206 but not on the source 204. The redundancy resulting from each of the data elements at the respective locations can be leveraged to verify any particular update by a comparison of the respective timestamps.

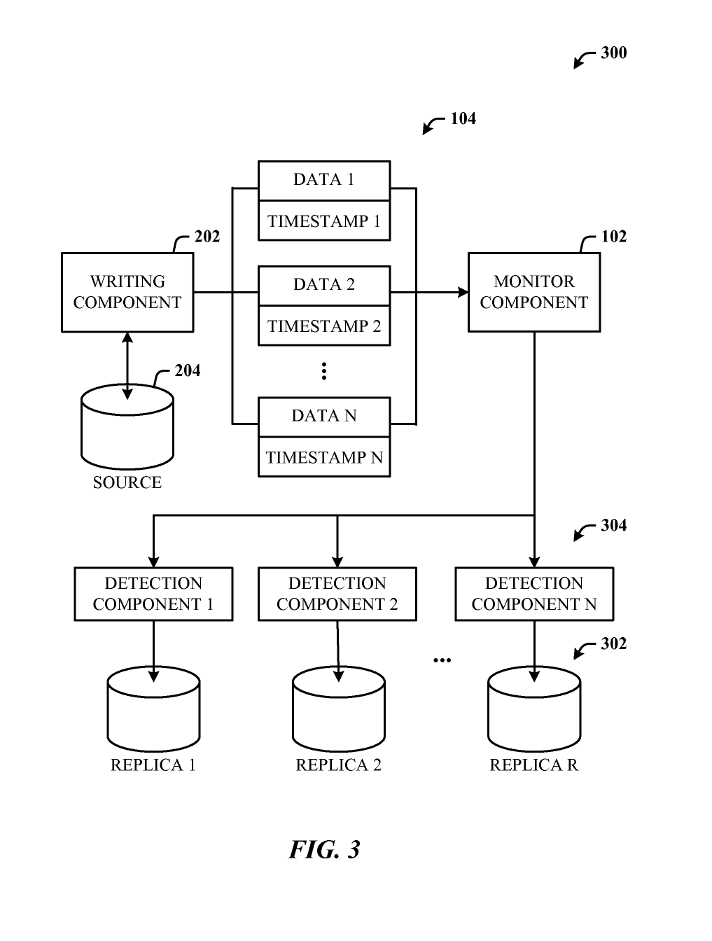

FIG. 3 illustrates an alternative embodiment of a data management system 300 for a single master replication embodiment. The writing component 202 reads data from the source data store 204 and writes the data elements 104 into the stream for communication to replica data stores 302. The data elements 104 also include timestamps that can indicate the position of the data elements 104 in the stream (e.g., earlier in the stream, later in the stream).

As also illustrated in FIG. 3, the monitor component 102 monitors the timestamps. The data elements 104 are written from the stream to replica data stores 302 so as to maintain multiple copies of the data elements 104. Detection components 304 are provided so that one corresponds to each of the replica data stores 302. In this manner, the detection components 304 perform evaluation independently of each of the replica data stores 302 for increased reliability and redundancy.

Note that the lost write detection architecture also applies to other replication embodiments (e.g., multi-master replication) where there can be P peer elements that replicate to each other.

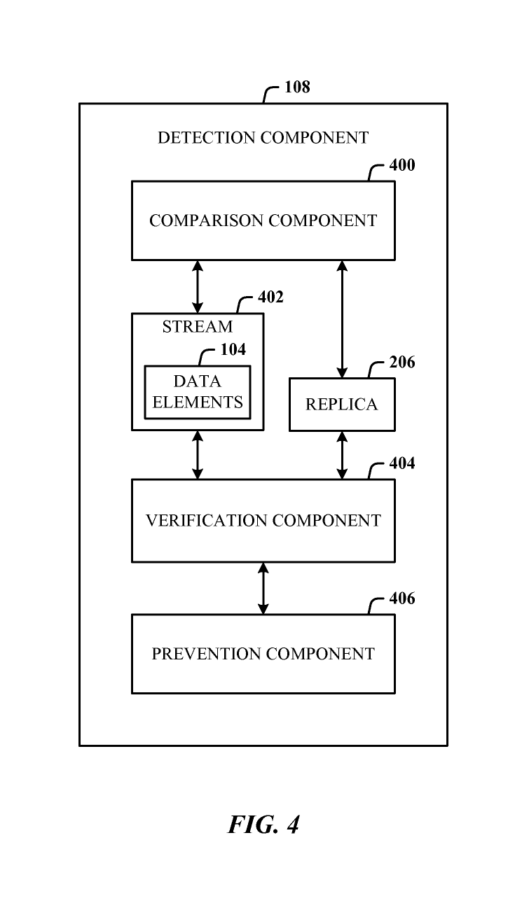

FIG. 4 illustrates components that can be optionally incorporated into the detection component 108. A comparison component 400 can be used for comparing the timestamps of respective data elements 104 in the replication stream 402 and the replica data store 206 to detect a mismatch in the respective timestamps corresponding to the lost writes. In other words, the comparison component compares the timestamps to detect lost writes based on a compare mismatch. The mismatch indicates lost writes in a source data store or a replica data store. The comparison component also compares timestamps to detect duplicate before timestamps for a given data location of the source data store, which indicate a lost write in the source data store.

Replicating the data elements 104 from the stream 402 can thereby allow detection of lost writes, since discrepancies are noted between the before timestamps of the data elements 104 in the stream and the associated timestamps in the replica data store 206. Additionally, a lost write in either the source data store 204 or in the replica data store 206 can be inferred by the comparison component 400 by comparing the respective timestamps in the stream with respect to the replica data store 206.

As depicted in FIG. 4, the detection component 108 can also include a verification component 404 for verifying the data elements 104 written to the replica data store 206 by comparing the respective timestamps against corresponding timestamps in one or more redundant replica data stores 206. The verification component 404 facilitates the application of timestamps to check entries so that the verification is deferred, reordered, or ignored to not be detected by the caches. In this way, verification can be made selective so that each check entry can be optionally selected or not selected, and thereby control the I/O requirements on the replica data store 206. The verification component 404 can also be employed for verifying the check entries using redundant copies of the timestamps of one or more replica data stores 206.

Alternatively, further to the embodiment of FIG. 3, a respective one of the detection components 304 can be used with each of the redundant replica data stores 302 to perform evaluation independently for increased reliability and redundancy. In using the redundant copies of the timestamps on one or more replicas, the verification component 404 increases the reliability of the source data store 204 and replica data store 206 without devoting additional resources.

Still alternatively, “logical protection” can be applied by obtaining check entries from pages and then use the check entries to compute a new check entry value for another page. This can be considered a self-test by periodically or randomly running this computation to check that pages of data do not include lost writes or other errors. This can be performed on either or both of the source data store or/and the replica data stores.

This relates to how to protect the master database in a situation where at least one replica is very close to up-to-date with that master (i.e., it is replaying updates in very near realtime). The idea was to emit check records for every page read by the master. In that case, the replica can very quickly verify that the data being read is not stale (due to a previous lost flush). If the data is stale, then the replica can notify the master in sufficient time to avoid committing any updates to the master database based on this stale data. This protects the master database from introducing further logical corruption in the database due to a previous lost flush operation.

For example, consider two bank accounts. The transaction is to read a balance in account A, check for a balance of more than $1000, subtract $1000, read a balance in account B, add $1000, and then commit (transfer the $1000). If there was a lost flush on the balance in account A, then it is possible to forget a previous withdrawal on that account that might have brought the balance below $1000. In that case, not only will the balance on account A be further corrupted, but money that does not really exist might get transferred to account B, spreading the corruption further.

There are multiple ways to prevent the logical corruption in this case: the master database can wait for confirmation (for some timeout) from the replicas that what it read is valid, or the master database can withhold updates to the database for some time. If the master gets an event declaring the source data of a transaction to be invalid, then the master can intentionally lose the updates after that point in time. The replicated system will lose some transactions, but it will maintain the logical consistency of the data.

As also illustrated in FIG. 4, a prevention component 406 can be included for receiving an output from the verification component 404 and preventing updates from the source data store 204 with duplicate before timestamps. The prevention component 406 uses the data from the stream and the data store 206 to identify lost writes and thus prevents update events with duplicate before timestamps, which can break the replication process.

If a comparison with the replica data store 206 indicates that a lost write has been detected in the source data store 204, further updates to that page are prevented. In this way, the prevention component 406 does not permit duplicate before timestamps in the transaction log file, since such a case causes replication to fail for all the replicas, destroying the redundancy of the system. In such situations, the system 100 (of FIG. 1) can selectively implement a page repair operation on the source data store 204 from the replica data store 206, thereby including the correct page data from the replica. In other words, a repair operation on the source data store 204 can be requested by a replica system in response to a lost write detected on the source data store 204 to repair the source data store 204 before further updates are stored on the source data store 204.

The following illustrative example is simply provided to depict an embodiment of implementing the aforementioned description and is not intended to limit the disclosed architecture. The source data store 204 is divided into various locations and each of the data elements 104 at each respective location has a timestamp. For example, a data element at location 100 has a timestamp value of 300. In the event that an update occurs to location 100 having a timestamp value of 400, an entry is added to the journal that includes the following information:

Update
Location Number=100
Timestamp Before=300
Timestamp After=400
<other details of the update operation>

The comparison component 400 can detect that the data element is also at location 100 of the replica data store 206 but has a timestamp of 350. Upon reading this update entry from the journal and comparing against the replica, the comparison component 300 detects that location 100 has a timestamp of 350 which is newer than the before timestamp from the source data store 204. This indicates that an update was lost in the source data store 204 at timestamp 350.

The lost write may have occurred because the location was written at timestamp 350, the hardware acknowledged the write, and the cached location data was removed from memory. Upon later reading the location back into memory from disk, the timestamp read 300 instead of 350. However, had the replica timestamp been smaller than 300, it can then be inferred that the lost write had instead occurred on the replica data store 206. In other words, if the before timestamp is less than the current timestamp, then the system can flag the page in the source data store 204 as having experienced a lost write. Conversely, if the before timestamp is greater than the current timestamp, then the system can flag the page in the replica data store 206 as having experienced a lost write.

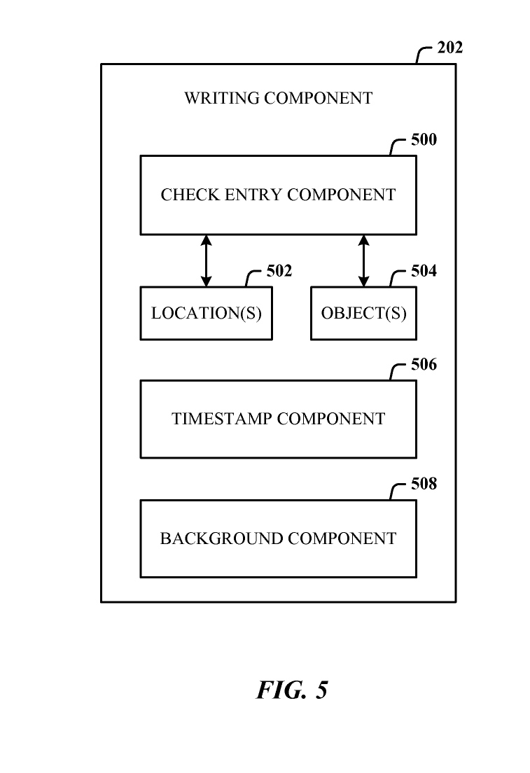

FIG. 5 illustrates components that can be optionally incorporated into the writing component 202. A check entry component 500 can be used for making check entries available in the replication stream 402 to perform indirect checks of the timestamps of locations in the source data store 204 against the replica data store 206. Each of the check entries recorded thereby corresponds to a predetermined number of data references and the respective timestamps. These data references can include physical file location(s) 502, as described hereinabove, as used with log shipping or other types of replication. In other words, the check entry component 500 inserts check entries in the data stream to detect lost writes in a replica data store. The check entries can be manipulated in time to avoid hardware effects such as cache memory operations.

The writing component 202 records entries into the replication stream 402 (of FIG. 4), and which is separate from the source data store 204 and the destination replica data store 206. (In a log shipping embodiment, this is a series of transaction log files.) The check records are conveyed as normal updates would be through the replication stream and do not update the replica data store 206 as other entries in that replication stream do. The check records are made available in the replication stream to perform indirect checks of the timestamps of locations in the source data store 204 against the replica data store 206 using entries in the stream that do not actually change the state of the replica data store 206.

Alternatively, the data references can also include a logical object(s) 504. A logical description can be included in a journal that describes a collection of the objects 504 instead of the physical locations 502. These objects 504 can include a name or a logical attribute of the data, with which the timestamps can be associated. For example, a data store can include an XML (extensible markup language) file having an element named “zebra” and a logical property can be associated therewith such as “stripes equals true.” In this way, a logical object 504 can be associated with the timestamp rather than a location 502, and thereby allow lost write detection on that basis.

Further to the description of FIG. 5, the writing component 202 can also include timestamp component 506 for assigning timestamps to each of the elements 104. The check entry component 500 can also be employed for assigning predetermined timestamp values to the check entries. These predetermined timestamp values can be outside the range of the respective data in the replica file. The timing indicated on the check entries can be manipulated by a background component 508 to sidestep the hardware caches that can defeat the timestamp checks. There are at least two timestamps. One timestamp is associated with each data location in the data store, and this timestamp can be viewed as a version number for the data element of the data store. A second timestamp is associated with the replication stream data elements. The stream data elements have an ordering, and a timestamp (or sequence number) can be used to identify that ordering. The timestamp component 506 can also assign before and after timestamp information to data elements 104 of the data stream, which before and after timestamps information used to infer state of the source data store 204 and/or the replica data stores 206.

Adding check entries to the transaction log increases the opportunities for detecting lost writes on the replica databases. The check entries are added when the system 200 scans the database looking for recently updated pages that are corrupted or requiring maintenance, based on the current timestamp and other database information. On the replica, the check entries have before and after timestamps that are the same as a previously used timestamp. A detected error can be processed asynchronously, so that although the error is reported, the error need not be immediately fixed. The replica can optionally ignore such records as the records do not affect the results of the replication process.

The ability to detect lost writes on commodity hardware can be used to drive another process for restoring the lost updates made to the source data store 204 by using information in the stream or in the replica data store(s) 206, and/or using information in the source data store 204 to repair the replica data store 206. The opportunity for making such repairs is driven by the redundancy available in the stream and also the replica data store(s) 206. This can enable the system 200 (e.g., messaging) to mitigate the problem of unreliable commodity storage.

Additionally, lost write detection as disclosed hereinabove can be used to drive other processes that increase the reliability of the system 200. In addition to using redundant data in the stream and in the data stores (204 and 206) to repair the lost write, the system 200 can also proactively detect lost writes on the source data store 204 and prevent future updates to those locations until the locations are repaired. This prevents situations which could break the replication process, such as when the stream contains multiple events with the same before timestamp.

Following is a series of flow charts representative of methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

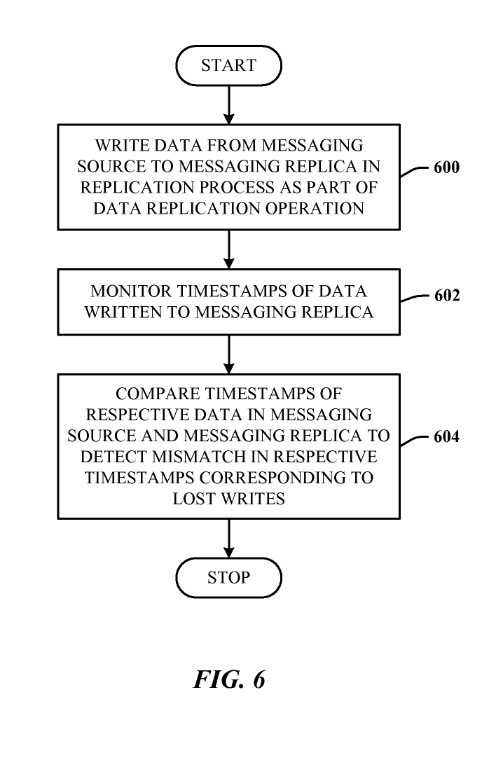

FIG. 6 illustrates a method of data management for lost write detection. At 600, data is written from a messaging source to a messaging replica as a part of a data replication. At 602, timestamps associated with the data written to the messaging replica are monitored. At 604, a comparison is performed between the timestamps of the respective data in the messaging source and the messaging replica. This is performed to detect a mismatch in the respective timestamps that corresponds to the lost writes.

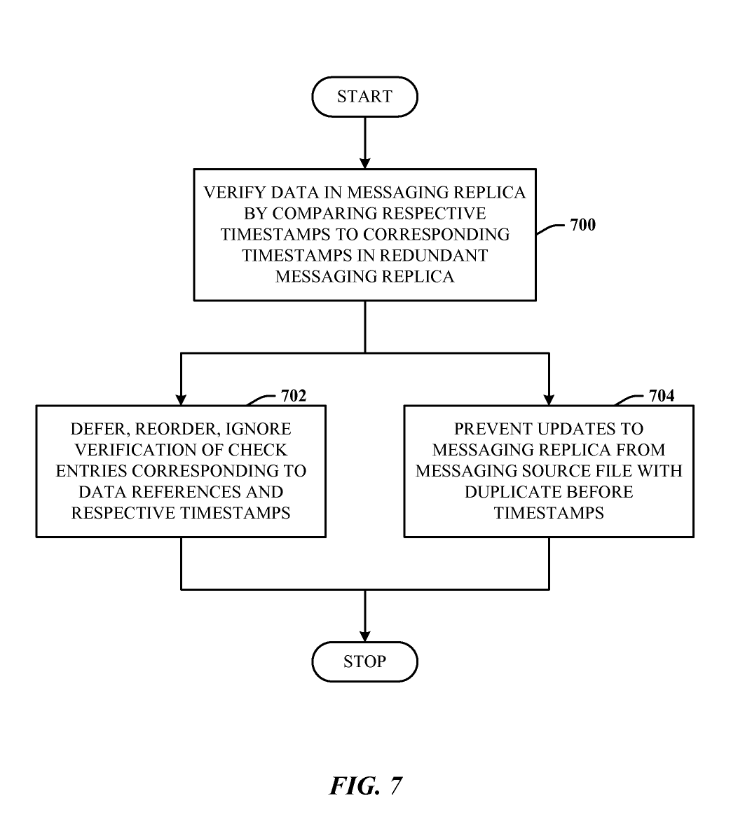

FIG. 7 illustrates alternative embodiments of the method disclosed hereinabove with respect to FIG. 6. At 700, the data in the messaging replica is verified by comparing the respective timestamps to corresponding timestamps in one or more redundant messaging replicas. This is for identifying damage or inconsistencies caused by lost writes. A first alternate embodiment of the verifying operation is shown at 702, where the verification of the data in the messaging replica can further include deferring, reordering, or ignoring verification of check entries corresponding to a predetermined number of data references and the respective timestamps. A second alternate embodiment of the verifying operation is shown at 704, where, subsequent to verifying the data in the messaging replica, updates can be prevented to the messaging replica from the messaging source with duplicate before timestamps. It is to be appreciated that these alternate embodiments (702 and 704) can also be performed together in any order.

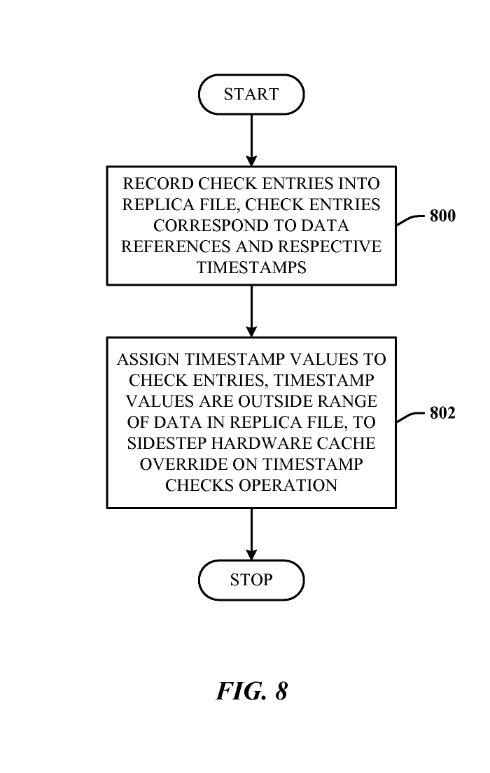

FIG. 8 illustrates additional alternative embodiments of the method disclosed hereinabove with respect to FIG. 6. As illustrated, flow indicates that either or both of the operations can be performed, as desired. At 800, check entries can be recorded into the messaging replica. The check entries correspond to a predetermined number of data references and the respective timestamps. These data references can include one or both of a physical location or a logical object type, as explicated hereinabove with respect to the description of the system. At 802, the recording of check entries can also include assigning predetermined timestamp values to the check entries. These predetermined timestamp values are outside a range of the respective data in the messaging replica, and in this way are able to sidestep a hardware cache override on a timestamp checks operation. The timestamps indicate the position of the data elements in the stream (e.g., earlier in the stream, later in the stream).

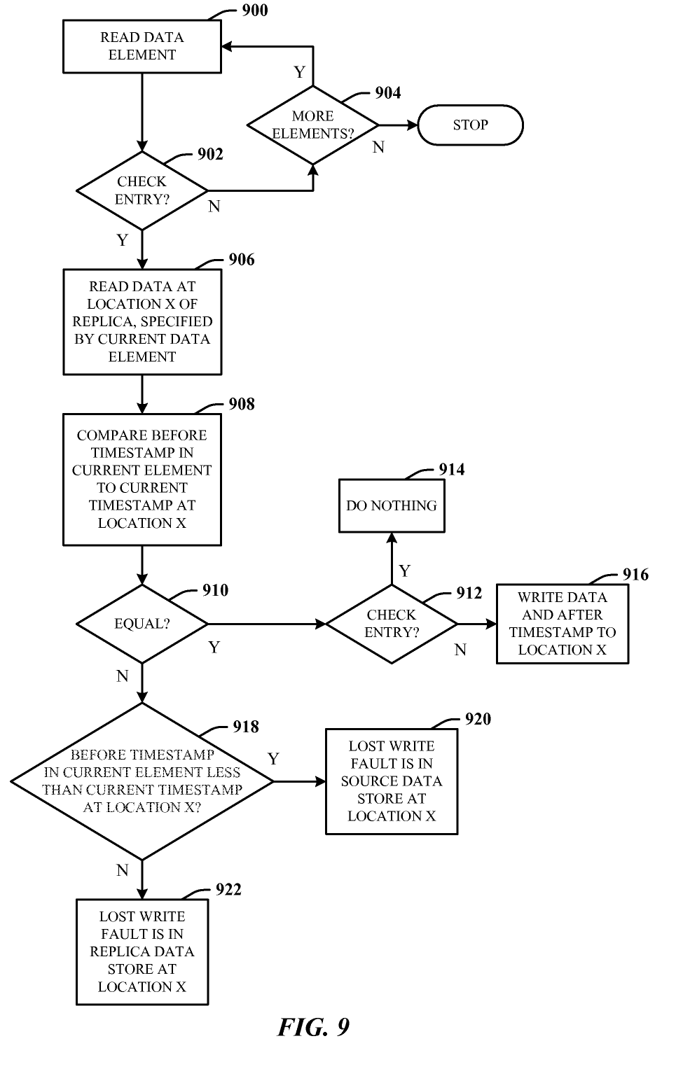

FIG. 9 is a flow chart illustrating further aspects of the process for lost write detection in a data management method. At 900, a next element is read from the data elements 104 in the stream, as explained hereinabove. A determination is made at 902 as to whether the data element is a check entry. If not, flow continues to 904 where a determination is made as to whether there are any more data elements 104 to read. If so, at 904, flow returns to 902 where the next element is read from the data elements 104 in the stream, and if not, the process ends.

If yes, at 902, the operation is optionally deferred and the process continues to 906 in which data is read at location X from the replica data store 206, where location X is specified from the current element. At 908, the before timestamp in the current element is compared to the current timestamp at location X. At 910, a decision is made as to whether the compared timestamps are equal.

If so, at 910, a decision is made at 912 as to whether the current element is a check entry. If so, nothing is done at 914. If not a check entry, the data and the after timestamp are written to location X, at 916. If the timestamps are not equal, at 910, flow proceeds to 918 where a decision is made as to whether the before timestamp in the current element is less than the current timestamp at location X. If so, the lost write fault is determined to be detected at location X in the source data store 204. If not, the lost write fault is determined to be detected at location X in the replica data store 206.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

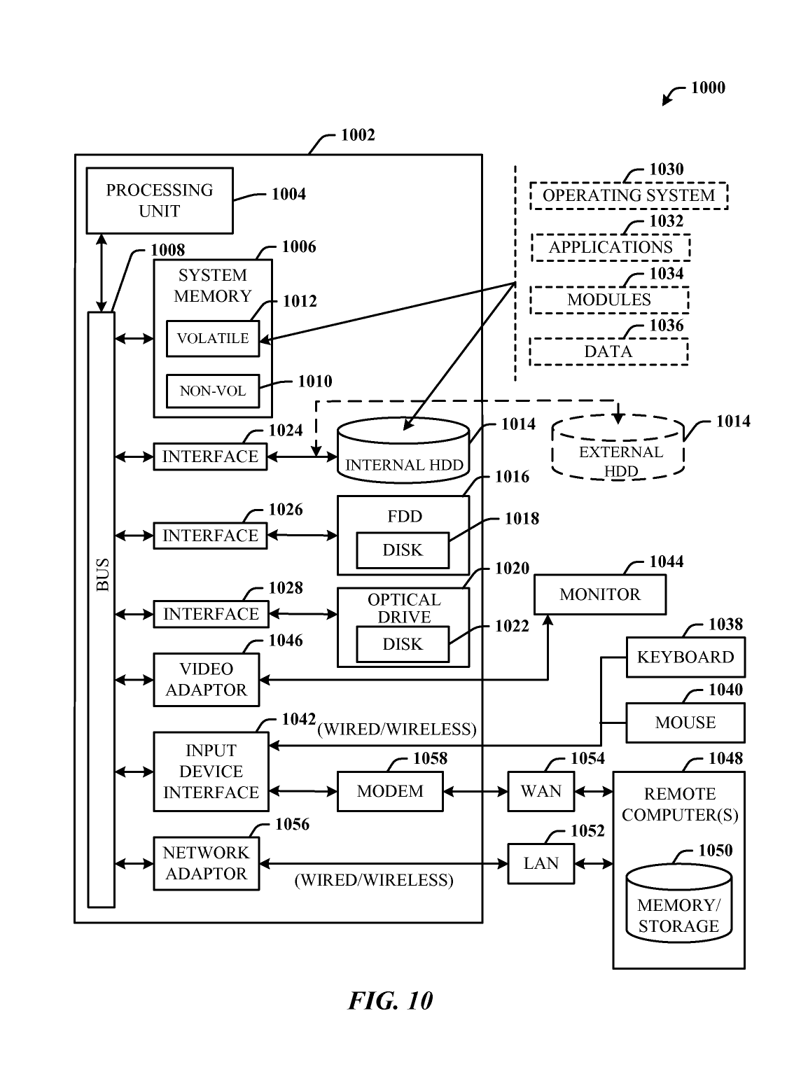

Referring now to FIG. 10, there is illustrated a block diagram of a computing system 1000 operable to execute lost write protection in accordance with the disclosed architecture. In order to provide additional context for various aspects thereof, FIG. 10 and the following discussion are intended to provide a brief, general description of a suitable computing system 100 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 10, the computing system 1000 for implementing various aspects includes a computer 1002 having a processing unit 1004, a system memory 1006 and a system bus 1008. The system bus 1008 provides an interface for system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 can include non-volatile memory (NON-VOL) 1010 and/or volatile memory 1012 (e.g., random access memory (RAM)). A basic input/output system (BIOS) can be stored in the non-volatile memory 1010 (e.g., ROM, EPROM, EEPROM, etc.), which BIOS are the basic routines that help to transfer information between elements within the computer 1002, such as during start-up. The volatile memory 1012 can also include a high-speed RAM such as static RAM for caching data.

The computer 1002 further includes an internal hard disk drive (HDD) 1014 (e.g., EIDE, SATA), which internal HDD 1014 may also be configured for external use in a suitable chassis, a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as a DVD). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the operating environment, and further, that any such media may contain computer-executable instructions for performing novel methods of the disclosed architecture.

A number of program modules can be stored in the drives and volatile memory 1012, including an operating system 1030, one or more application programs 1032, other program modules 1034, and program data 1036. All or portions of the operating system, applications, modules, and/or data can also be cached in the volatile memory 1012. It is to be appreciated that the disclosed architecture can be implemented with various commercially available operating systems or combinations of operating systems.

The aforementioned application programs 1032, other program modules 1034, and program data 1036 can include the computer-implemented data management system 100, the monitor component 102, the data elements 104, the replication process 106, the detection component 108, and the detected lost writes 110 of FIG. 1, the computer-implemented data management system 200, the writing component 202, the source data store 204, and the replica data store 206 from FIG. 2, the computer-implemented data management system 300, replica data stores 304, and the detection components 304 from FIG. 3, for example. The application programs 1032, other program modules 1034, and program data 1036 can also include the components that cooperate with the detection component 108 as shown in FIG. 4, namely, the comparison component 400, the replica stream 402, the verification component 404, and the prevention component 406, along with components that cooperate with the writing component 202 as shown in FIG. 5, namely, the check entry component 500, the physical file location(s) 502, the logical object(s) 504, the variable timestamp component 506, and background component 508, for example, as well as the methods depicted in FIGS. 6-9.

A user can enter commands and information into the computer 1002 through one or more wire/wireless input devices, for example, a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, etc.

A monitor 1044 or other type of display device is also connected to the system bus 1008 via an interface, such as a video adaptor 1046. In addition to the monitor 1044, a computer typically includes other peripheral output devices (not shown), such as speakers, printers, etc.

The computer 1002 may operate in a networked environment using logical connections via wire and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, is connected to the system bus 1008 via the input device interface 1042. In a networked environment, program modules depicted relative to the computer 1002, or portions thereof, can be stored in the remote memory/storage device 1050. It will be appreciated that the network connections shown are examples and other means of establishing a communications link between the computers can be used.

The computer 1002 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

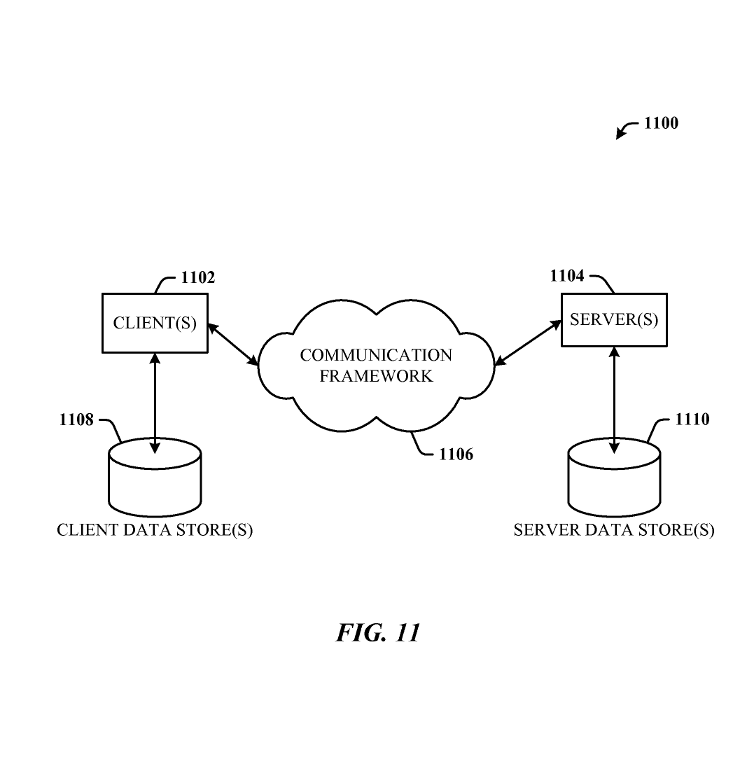

Referring now to FIG. 11, there is illustrated a schematic block diagram of a computing environment 1100 that facilitates lost write protection in accordance with the disclosed architecture. The environment 1100 includes one or more client(s) 1 102. The client(s) 1102 can be hardware and/or software (e.g., threads, processes, computing devices). The client(s) 1102 can house cookie(s) and/or associated contextual information, for example.

The environment 1100 also includes one or more server(s) 1104. The server(s) 1104 can also be hardware and/or software (e.g., threads, processes, computing devices). The servers 1104 can house threads to perform transformations by employing the architecture, for example. One possible communication between a client 1102 and a server 1104 can be in the form of a data packet adapted to be transmitted between two or more computer processes. The data packet may include a cookie and/or associated contextual information, for example. The environment 1100 includes a communication framework 1106 (e.g., a global communication network such as the Internet) that can be employed to facilitate communications between the client(s) 1102 and the server(s) 1 104.

Communications can be facilitated via a wire (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 11 04.

The aforementioned client(s) 1102, server(s) 1104, client data store(s) 1108, and server data store(s) 1110 can include can include the computer-implemented data management system 100, the monitor component 102, the data elements 104, the replication process 106, the detection component 108, and the detected lost writes 110 of FIG. 1, the computer-implemented data management system 200, the writing component 202, the source data store 204, and the replica data store 206 from FIG. 2, the computer-implemented data management system 300, replica data stores 304, and the detection components 304 from FIG. 3, for example. The client(s) 1102, server(s) 1104, client data store(s) 1108, and server data store(s) 1110 can also include the components that cooperate with the detection component 108 as shown in FIG. 4, namely, the comparison component 400, the replica stream 402, the verification component 404, and the prevention component 406, along with components that cooperate with the writing component 202 as shown in FIG. 5, namely, the check entry component 500, the physical file location(s) 502, the logical object(s) 504, the variable timestamp component 506, and the background component 508, for example.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented data management system, comprising:
a monitor component for monitoring timestamps of data as part of data replication using a data stream; and
a detection component for detecting lost writes based in part on the timestamps.

2. The system of claim 1, further comprising a comparison component for comparing the timestamps to detect lost writes based on a compare mismatch, the mismatch indicating lost writes in a source data store or a replica data store.

3. The system of claim 1, further comprising a comparison component for comparing timestamps to detect duplicate before timestamps for a given data location of a source data store, which indicates a lost write in the source data store.

4. The system of claim 1, further comprising a check entry component for inserting check entries in the data stream to detect lost writes in a replica data store.

5. The system of claim 4, wherein the check entries are manipulated in time to avoid hardware effects.

6. The system of claim 4, further comprising a verification component for verifying the check entries using redundant copies of the timestamps of one or more replica data stores.

7. The system of claim 6, wherein verification of the check entries is deferred, reordered, or ignored to reduce impact on a replica data store.

8. The system of claim 6, further comprising a prevention component that uses an output of the verification component to prevent creation of update events with duplicate before timestamps.

9. The system of claim 1, wherein a repair operation on a source data store is requested by a replica system in response to a lost write detected on the source data store to repair the source data store before further updates are stored on the source data store.

10. The system of claim 1, further comprising a timestamp component for assigning before and after timestamp information to data elements of the data stream, which before and after timestamp information is used to infer state of a source data store and a replica data store.

11. A computer-implemented data management system, comprising:
a monitor component for monitoring timestamps of data written to a messaging replica data store via a data stream; and
a detection component for detecting lost writes by comparing the timestamps of the data in the messaging source data store and the messaging replica data store to detect a mismatch in the respective timestamps that correspond to the lost writes.

12. The system of claim 11, further comprising a comparison component for comparing the timestamps to detect lost writes based on a compare mismatch, the mismatching indicating lost writes in a source data store or a replica data store.

13. The system of claim 11, further comprising a check entry component for inserting check entries into a data stream of a master data store for determining state of the master data store and preventing new updates to the master data store, where the check entries indicate lost writes on the master data store.

14. The system of claim 11, further comprising a verification component for verifying the check entries using redundant copies of the timestamps of one or more replica data stores, the verification of the check entries is deferred, reordered, or ignored to reduce impact on a replica data store.

15. The system of claim 11, further comprising a timestamp component for assigning before and after timestamp information to data elements of the data stream, which before and after timestamp information is used to infer state of a source data store and a replica data store.

16. A method of managing data, comprising:
writing data from a messaging source to a messaging replica in a replication process as part of data replication;
monitoring timestamps of the data written to the messaging replica; and
comparing the timestamps of the respective data in the messaging source and the messaging replica to detect a mismatch in timestamps that correspond to the lost writes.

17. The method of claim 16, further comprising verifying the data in the messaging replica by comparing the respective timestamps to corresponding timestamps in at least one redundant messaging replica to identify damage caused by lost writes.

18. The method of claim 17, wherein verifying the data in the messaging replica further comprises deferring, reordering, or ignoring verification of check entries corresponding to a predetermined number of data references and the respective timestamps.

19. The method of claim 17, further comprising preventing updates to the messaging replica from the messaging source with duplicate before timestamps.

20. The method of claim 16, further comprising recording check entries into the messaging replica, the check entries correspond to a predetermined number of data references and the respective timestamps.
